(19) United States
(12) Patent Application Publication
(10) Pub. No.: US 2025/0361435 A1
(43) Pub. Date: Nov. 27, 2025

(54) CEMENTITIOUS MIXTURE FOR CEMENTING A WELLBORE

(71) Applicant: KING FAHD UNIVERSITY OF PETROLEUM AND MINERALS, Dhahran (SA)

(72) Inventors: Ahmed Abdulhamid Ahmed MAHMOUD, Dhahran (SA); Salaheldin Mahmoud Ahmed Ahmed ELKATATNY, Dhahran (SA)

(73) Assignee: KING FAHD UNIVERSITY OF PETROLEUM AND MINERALS, Dhahran (SA)

(21) Appl. No.: 19/070,393

(22) Filed: Mar. 4, 2025

Related U.S. Application Data
(60) Provisional application No. 63/651,181, filed on May 23, 2024.

(51) Int. Cl. C09K 8/48; C04B 14/30; C04B 103/00; C09K 8/487; E21B 33/138

(52) U.S. Cl. CPC C09K 8/48; C04B 14/308; C09K 8/487; E21B 33/138; C04B 2103/0035; C04B 2103/0068

(57) ABSTRACT

A method of cementing a well includes injecting a cementitious mixture into a cased wellbore at a depth of at least 10,000 feet. The cementitious mixture is injected into an annulus between a casing and a wellbore wall. The method further includes curing the cementitious mixture to form a cured cement connecting the casing to the wellbore wall. The cementitious mixture includes a class G cement in an amount of 40 to 50 percent by weight (wt. %), water in an amount of 15 to 25 wt. %, a retarder in an amount of 0.5 to 1 wt. %, a dispersant in an amount of 0.05 to 0.2 wt. %, a fluid loss additive in an amount of 0.1 to 0.3 wt. %, a defoamer in an amount of 0.001 to 0.05 wt. %, a silica flour in an amount 10 to 20 wt. %, and magnetite in an amount of 10 to 20 wt. % where the wt. % is based on a total weight of the cementitious mixture.

### CROSS REFERENCE TO RELATED APPLICATION

This application claims the benefit of U.S. Provisional Application No. 63/651,181, filed May 23, 2024, which is incorporated herein by reference in its entirety.

### STATEMENT REGARDING PRIOR DISCLOSURE BY THE INVENTORS

Aspects of the present disclosure are described in Alvayed, D. et al., “The Effect of the Heavyweight Hematite, Magnetite, and Micromax on Class G Oil Well Cement Properties” presented at the 57^{th} U.S. Rock Mechanics/Geomechanics Symposium (2023), which is incorporated herein by reference in its entirety.

### BACKGROUND

### Technical Field

The present disclosure is directed to a method of cementing a well with a cementitious mixture, and more particularly, towards cementing an oil well with a magnetite based cementitious mixture.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

With the progression of civilization, demand for oil and gas has increased multifold. Multiple oil wells are drilled every day to satisfy high energy demands; however, traditional drilling practices may not generate wellbores of high integrity. When dealing with unbalanced wellbores, deformable/plastic formations and/or high pore pressures, high mud weight above 18 pounds per gallon (ppg) may be utilized and/or cement samples of equivalent weight may be used. The well may never produce the total capacity of the well without effectively isolating problematic zones. Oil-well cementing procedures may be carried out to counteract wellbores of low integrity. To create a cement layer with practical integrity, a plurality of additives (weighting agents) may be used in cement slurry formulation.

Weighting materials may be used to increase density of a drilling fluid to balance higher pressures in deep wells. When added to a drilling fluid, a weighting agent may cause the density of the liquid to increase. By mixing a weighting agent into a cement slurry, the weight may be increased. Common weighting materials for deep oil wells may include barite (barium sulphate), hematite (iron oxide), limestone, calcium carbonate, and/or gilsonite. Barite is most used due to its high density. Hematite is used in higher-density situations, while limestone and calcium carbonate may be used in less demanding conditions. Limestone and calcium carbonate may not provide sufficient weight, while gilsonite may cause handling difficulties. Limestone, calcium carbonate, and gilsonite have lower densities compared to barite and hematite, rendering them less effective in high-pressure deep oil wells. Such materials also may be more expensive and/or less widely available. Although adding weighting agents to a cement slurry may change the properties of cement, limited research has been done to study alterations in cement properties by adding weighting agents.

Hematite is largely utilized as a weighting material in oil fields; however, hematite use raises operational and environmental issues and may cause abrasion of drilling equipment. Weighting components may degrade the homogeneity of cement by generating a cement slurry with different densities axially along a cement body where solid segregation may become an issue. Segregation of cement solids may affect cement characteristics such as porosity, permeability, and compressive strength. Hematite may cause segregation in cement slurries used in wellbores due to its high density and specific gravity. Hematite particles are heavier in weight and tend to settle down at the bottom of a slurry, leading to stratification. Segregation affects the uniformity of slurry and compromises a cement job quality and wellbore isolation if not properly mixed.

In drilling fluid properties, rheological parameters are influenced by the weighting materials. The rheological property effect also applies to cement. The quality of cement systems may also suffer from excessive fluid loss. In parallel to segregation issues, altered mechanical characteristics of moistened well cement are anticipated in oil wells with high pressure and high temperature (HPHT) situations due to the negative impact of temperature on the cement hydration products [Caritey, J. P. and Brady, J. Performance of thermal cements with different weighting materials, SPE/IADC Drilling Conference, Proceedings, 2013, 2; Costa, B. L. de S. et al.,. Silica content influence on cement compressive strength in wells subjected to steam injection, Journal of Petroleum Science and Engineering, 2017, 158; and Karim, M. R. et al., Effect of elevated temperatures on compressive strength and microstructure of cement paste containing palm oil clinker powder, Construction and Building Materials, 2018, 183]. Although several weighting agent compositions for cementing wells have been developed in the past, there is still a need to fabricate and explore a better and more effective weighting agent composition and method for cementing oil wellbore operations.

Accordingly, an object of the present disclosure is to provide a magnetite based weighting agent for cementing a well that may circumvent drawbacks, such as environmental toxicity, high density, low efficiency, high segregation, and/or high-cost factor, of materials known in the art.

### SUMMARY

In an exemplary embodiment, a method of cementing a well is described. The method includes injecting a cementitious mixture into a cased wellbore at a depth of at least 10,000 feet, where the cementitious mixture is injected into an annulus between a casing and a wellbore wall. The method further includes curing the cementitious mixture to form a cured cement connecting the casing to the wellbore wall. The cementitious mixture includes a class G cement in an amount of 40 to 50 percent by weight (wt. %), water in an amount of 15 to 25 wt. %, a retarder in an amount of 0.5 to 1 wt. %, a dispersant in an amount of 0.05 to 0.2 wt. %, a fluid loss additive in an amount of 0.1 to 0.3 wt. %, a defoamer in an amount of 0.001 to 0.05 wt. %, a silica flour in an amount 10 to 20 wt. %, and magnetite in an amount of 10 to 20 wt. %. Percent by weight (wt. %) is based on a total weight of the cementitious mixture.

In some embodiments, the magnetite includes at least 95 wt. % iron based on the total weight of atoms other than oxygen in the magnetite.

In some embodiments, the magnetite includes at least 99 wt. % iron based on the total weight of atoms other than oxygen in the magnetite.

In some embodiments, the magnetite has a particle size of 15 to 20 micrometers (um).

In some embodiments, the magnetite has a specific gravity of 5 to 5.5.

In some embodiments, the cementitious mixture is cured in the well at a pressure of 2500 to 3500 pounds per square inch (psi) and a temperature of 270 to 320 degrees Fahrenheit (° F.) for 20 to 24 hours.

In some embodiments, the cured cement has a compressive strength of 60 to 70 megapascal (MPa).

In some embodiments, the cured cement has a permeability of 0.0025 to 0.0035 millidarcy (mD).

In some embodiments, the cured cement has a density dissimilarity of 5 to 8%.

In some embodiments, the cured cement has a tensile strength of 6 to 10 MPa.

In some embodiments, the cured cement has a porosity of 20 to 24%.

In some embodiments, the cementitious mixture further includes hematite.

In some embodiments, the hematite includes at least 95 wt. % iron based on the total weight of atoms other than oxygen in the hematite.

In some embodiments, the hematite has a particle size of 15 to 20 um.

In some embodiments, the cementitious mixture is cured in the well at a pressure of 2500 to 3500 psi and a temperature of 270 to 320° F. for 20 to 24 hours.

In some embodiments, the cured cement has a compressive strength of 45 to 55 MPa.

In some embodiments, the cured cement has a permeability of 0.003 to 0.004 mD.

In some embodiments, the cured cement has a density dissimilarity of 8 to 10%.

In some embodiments, the cured cement has a tensile strength of 4 to 8 MPa.

In some embodiments, the cured cement has a porosity of 21 to 25%.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic flow chart of a method of cementing a well, according to certain embodiments.

FIG. 2A depicts particle size distribution (PSD) for hematite, according to certain embodiments.

FIG. 2B depicts particle size distribution (PSD) for magnetite, according to certain embodiments.

FIG. 3A is a scanning electron microscopy (SEM) image of hematite as a weighting agent, according to certain embodiments.

FIG. 3B is an SEM images of magnetite as a weighting agent, according to certain embodiments.

FIG. 4A is a schematic diagram depicting a design for an exemplary crushing machine, according to certain embodiments.

FIG. 4B is a schematic diagram depicting a design for an exemplary helium porosimeter, according to certain embodiments.

FIG. 4C is a schematic diagram depicting a design for an exemplary gas permeameter, according to certain embodiments.

FIG. 5 depicts densities of hematite and magnetite incorporated cement cylinders cured at high pressure and high temperature (HPHT), according to certain embodiments.

FIG. 6 depicts compressive strength of hematite and magnetite cement cured at HPHT for 24 hours, according to certain embodiments.

FIG. 7 depicts tensile strength of hematite and magnetite cement cured at HPHT for 24 hours, according to certain embodiments.

FIG. 8 depicts porosity and permeability of hematite-based and magnetite-based samples cured at HPHT, according to certain embodiments.

### DETAILED DESCRIPTION

When describing the present disclosure, the terms used are to be construed in accordance with the following definitions, unless a context dictates otherwise.

Embodiments of the present disclosure will now be described more fully hereinafter with reference to the accompanying drawings wherever applicable, in that some, but not all, embodiments of the disclosure are shown.

In the drawings, like reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of the present disclosure are directed to the development of a method and a composition of a cement slurry with qualities, such as high density, for cementing deep and ultra-deep oil wells. While hematite has traditionally been used as a weighting material in such applications, it presents operational and environmental challenges, including cement segregation and the creation of a non-elastic cement matrix. The present disclosure explores the use of magnetite as an alternative weighting component in cementing operations at a depth of 15,000 feet. Magnetite-based cement slurries may offer improved performance in terms of compressive strength, elasticity, and low permeability, presenting a solution for deep well cementing.

As used herein, the term “compressive strength” refers to the ability of a material to withstand axial loads that tend to compress or shorten the material, measured as the maximum stress a material can endure without failure under compression. It is typically expressed in units of pressure, such as megapascals (MPa).

As used herein, the term “permeability” refers to the property of a material that indicates its ability to allow fluids to pass through it. It is typically measured in units of darcies or millidarcies (mD) and depends on the material's porosity and the size and connectivity of its pores.

As used herein, the term “tensile strength” refers to the maximum amount of pulling or stretching (tensile) stress a material can withstand before breaking or failing. It is a measure of a material's resistance to deformation under tension and is typically expressed in units of force, such as megapascals (MPa).

As used herein, the term “porosity” refers to the measure of the empty spaces (pores) within a material, typically expressed as a percentage of the total volume. It indicates the material's ability to hold fluids and/or gaseous material, such as water, oil, or gas. Higher porosity means more void spaces, allowing for greater fluid storage.

Magnetite is a naturally occurring iron oxide mineral (Fe₃O₄) known for its strong magnetic properties. It may be used as a dense material in applications like cement slurries to increase density. Magnetite is typically black or brownish black in color.

Hematite is an iron oxide mineral (Fe₂O₃) that is commonly found in sedimentary rocks. It is typically reddish-brown or metallic gray in color and is a primary ore of iron. Hematite is used in various industrial applications, including steel production, and as a pigment in paints. It may also added to cement slurries to increase density.

As used herein, the term “annulus” or “annular” refers to the gap between a casing (a tubular structure inserted into the wellbore) and a formation or rock surrounding a wellbore.

Cement and/or other fluids may be injected into this annular space to provide zonal isolation, structural support, and prevent fluid migration between different layers of rock.

As used herein, the term “density dissimilarity” refers to the density fluctuation of material in a sample (i.e., a cementitious slurry, a cement, a cured cement) along the sample (i.e., from top to bottom, from left to right). Density dissimilarity may be used to determine separation of material in a sample.

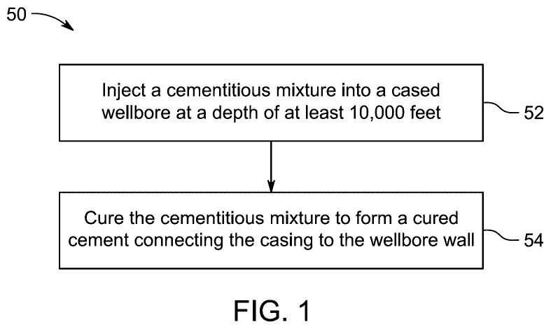

Referring to FIG. 1, a method 50 of cementing a well is described. Cementing a well is a process of placing cement between a wellbore and a casing to secure the casing, seal off underground formations, protect the casing from corrosion, and enable well control. Cementing the well ensures the stability, safety, and long-term functionality of the well by preventing fluid migration, protecting against formation pressures, and maintaining structural integrity. The order in which the method 50 is described is not intended to be construed as a limitation, and any number of the described method 50 steps may be combined in any order to implement the method 50. Additionally, individual steps may be removed or skipped from method 50 without departing from the spirit and scope of the present disclosure.

At step 52, the method 50 includes injecting a cementitious mixture into a cased wellbore at a depth of at least 10,000 feet, preferably at least 11,000 feet, preferably at least 12,000 feet, preferably at least 13,000 feet, preferably at least 14,000 feet, and yet more preferably at least 15,000 feet. In other embodiments, the method 50 includes injecting the cementitious mixture into a cased wellbore at a depth of 10,000 to 30,000 feet.

The cementitious mixture includes a class G cement in an amount of 40 to 50 percent by weight (wt. %), preferably 46 to 49 wt. %, more preferably 47 to 48 wt. %, and yet more preferably about 47.24 wt. %, based on a total weight of the cementitious mixture. Class G cement is a type of oilfield-grade Portland cement used in well cementing applications. It is designed to withstand high-pressure and high-temperature environments. Class G cement provides good compressive strength and durability. In a preferred embodiment, the class G cement is based on a Saudi Class G cement. In other embodiments, in addition to class G cement, other cements including, but not limited to, class A cement, class C cement, class H cement, class K cement, pozzolanic cement, blast furnace slag cement, sulfate-resistant cement, high-alumina cement, rapid-hardening cement, Portland-limestone cement, white Portland cement, geopolymer cement, calcium aluminate cement, oilwell cement, microfine cement, expanded perlite cement, fly ash-based cement, silica fume cement, expanded clay cement, magnesium phosphate cement, high-strength concrete, resin-based cement, lightweight cement, polyurethane cement, rubberized concrete, quick-setting cement, hydraulic lime, Portland cement with additives, aerated concrete, ultra-high-performance concrete (UHPC), rubberized concrete, and the like may be used in place of or in combination with the class G cement. In some embodiments, the class G cement has a specific gravity of 2 to 4, preferably 2.5 to 3.5, more preferably 3 to 3.3, and yet more preferably about 3.15.

The cementitious mixture further includes water in an amount of 15 to 25 wt. %, preferably 17 to 23 wt. %, more preferably 19 to 22 wt. %, and yet more preferably about 20.79 wt. %, based on a total weight of the cementitious mixture. The water may be tap water, distilled water, bi-distilled water, deionized water, deionized distilled water, reverse osmosis water, salt water, waste water, a combination thereof, and/or some other water.

The cementitious mixture further includes a retarder in an amount of 0.5 to 1 wt. %, preferably 0.6 to 0.9 wt. %, more preferably 0.7 to 0.8 wt. %, and yet more preferably about 0.71 wt. % based on a total weight of the cementitious mixture. A retarder is a substance added to a mixture, such as cement, to slow down a chemical reaction, typically the setting or hardening process. In cementing, retarders are used to extend the working time of the cement slurry, allowing for easier handling and application in wells. Suitable examples of a retarder may include, but are not limited to, calcium chloride, sodium citrate, lignosulfonates, sodium gluconate, potassium chloride, triethanolamine, borax, calcium formate, potassium carbonate, sucrose, glucose, polyacrylamide, citric acid, phosphates, tartaric acid, sugar, sodium polyphosphate, formic acid, ammonium sulfate, citric acid esters, lignin-based retarders, polyethylene glycol, sodium lauryl sulfate, starch derivatives, carboxymethyl cellulose, calcium lignosulfonate, magnesium sulfate, guar gum, sodium silicate, potassium tartrate, urea, a combination thereof, and the like. In a preferred embodiment, the retarder is a lignosulfonate-based chemical, preferably a calcium lignosulfonate.

The cementitious mixture further includes a dispersant in an amount of 0.05 to 0.2 wt. %, preferably 0.08 to 0.17 wt. %, more preferably 0.1 to 0.15 wt. %, and yet more preferably about 0.12 wt. % based on a total weight of the cementitious mixture. A dispersant is a chemical additive used to break up or spread-out particles within a mixture, preventing the particles from clumping or settling. In cementing, dispersants help improve the flowability and uniformity of cement slurries by reducing viscosity and promoting better dispersion of solid particles. Suitable examples of a dispersant may include, but are not limited to, sodium silicate, polyacrylate, lignosulfonate, polycarboxylate, sodium hexametaphosphate, phosphonate, polyphosphate, styrene-butadiene copolymer, carboxymethyl cellulose, hydroxyethyl cellulose, guar gum, modified guar gum, xanthan gum, hydroxypropyl guar, polyvinyl alcohol, polystyrene sulfonate, sodium tripolyphosphate, sodium citrate, sodium gluconate, calcium gluconate, polyethoxylated fatty acid, polyacrylamide, acrylic acid derivatives, ethylene glycol, glycerol, silica-based dispersants, polyetheramines, polyether sulfonates, sodium lauryl sulfate, polyether polyols, a combination thereof, and the like. In a preferred embodiment, the dispersant is a naphthalene sulfonate-based chemical, preferably a polynaphthalene sulfonate.

The cementitious mixture includes a fluid loss additive in an amount of 0.1 to 0.3 wt. %, preferably 0.15 to 0.28 wt. %, more preferably 0.2 to 0.25 wt. %, and yet more preferably about 0.24 wt. % based on a total weight of the cementitious mixture. A fluid loss additive is a chemical agent added to cement slurries or drilling fluids to reduce the loss of liquid to the surrounding formations. It helps maintain the integrity of the slurry by preventing excessive fluid leakage, promoting proper bonding, and reducing the risk of formation damage. Suitable examples of fluid loss additive may include, but are not limited to, sodium bentonite, starch, cellulose, polyanionic cellulose (PAC), xanthan gum, guar gum, carboxymethyl cellulose, polyacrylamide, calcium carbonate, lignosulfonates, hydroxyethyl cellulose, calcium lignosulfonate, attapulgite, gilsonite, gilsonite derivatives, polyethylene oxide, polyvinyl alcohol, sodium carboxymethyl cellulose, polyacrylic acid, sodium silicate, asphalt, potassium chloride, lignin derivatives, sodium alginate, microfine silica, montmorillonite, diatomaceous earth, sodium phosphates, magnesium silicate, latex, acrylic polymers, polyethoxylated fatty acids, polycarboxylate, polyetheramine, polyether sulfonates, polyhydroxyethyl methacrylate, polyvinylpyrrolidone, polymethylmethacrylate, polypropylene, polyethylene glycol, polyethylene oxide, ethoxylated amines, ethoxylated alcohols, sodium tripolyphosphate, aluminum sulfate, iron oxide, kaolin, bentonite clay, activated carbon, guar derivatives, starch derivatives, emulsifiers, surfactants, hydrophilic polymers, hydrophobic polymers, polyglutamic acid, polybutadiene, polyvinyl acetate, polyisobutene, polyethylene glycol monostearate, ethylene glycol, isopropyl alcohol, sodium carbonate, sodium bicarbonate, sodium hydroxide, magnesium hydroxide, potassium hydroxide, sulfur, citric acid, phosphates, sodium citrate, citric esters, sodium formate, calcium formate, magnesium formate, potassium formate, guar gum derivatives, chitosan, methylcellulose, ammonium polyphosphate, zinc oxide, carbon black, titanium dioxide, barium sulfate, aluminum oxide, sodium carbonate, sodium bicarbonate, ferric chloride, sodium lauryl sulfate, sodium dodecylbenzene sulfonate, ethylene glycol monobutyl ether, ethylhexyl stearate, dimethyl sulfoxide, butyl rubber, methyl vinyl ether, neoprene, ethylene propylene diene monomer, styrene-butadiene rubber, styrene-acrylonitrile, polyvinylidene fluoride, polybutylene, polyurea, polystyrene, polycaprolactam, polyvinylbutyral, polyhydroxypropyl cellulose, polysaccharides, polycarboxylates, polyisocyanates, water-soluble polymers, oil-soluble polymers, polyglycol, glycol ethers, polyether-amine, polyethylenimine, polypropyl glycol, carboxylated polymers, polyisoprene, nonionic surfactants, amphoteric surfactants, anionic surfactants, cationic surfactants, polymaleic anhydride, ethylene glycol ethers, polypropylene glycol, sodium polymethacrylate, polybutene, poly(ethylene glycol)-block-poly(propylene glycol), silica aerogels, boron oxide, silicate minerals, aluminum silicates, mineral oils, fatty alcohols, a combination thereof, and the like. In a preferred embodiment, the fluid loss additive is an SFL-SA and/or SwellPlug lost circulation materials (SwellCM) from TAQA.

The cementitious mixture includes a defoamer in an amount of 0.001 to 0.05 wt. %, preferably 0.005 to 0.03 wt. %, and more preferably 0.01 to 0.02 wt. % based on a total weight of the cementitious mixture. A defoamer is a chemical additive used to reduce or eliminate foam in liquids. In cementing or drilling operations, it helps prevent the formation of foam in the slurry, ensuring proper flow and consistency while improving the efficiency of the mixing and pumping processes. Suitable examples of a defoamer may include, but are not limited to, silicon-based defoamers, polyethylene glycol, polypropylene glycol, polyether-modified silicones, stearyl alcohol, oleyl alcohol, polyvinyl alcohol, polysiloxanes, ethoxylated fatty acids, ethoxylated alcohols, dimethylsilicone, methylsilicone, silicone emulsions, silicone oils, mineral oils, fatty acid esters, alkyl polyglycosides, glycol esters, polybutene, polyisobutene, polyacrylate, polystyrene, sodium lauryl sulfate, sodium dodecylbenzene sulfonate, ammonium lauryl sulfate, sorbitan esters, polyetheramines, polycarboxylate, nonionic surfactants, amphoteric surfactants, anionic surfactants, cationic surfactants, methylcellulose, guar gum derivatives, silicone waxes, polydimethylsiloxane, polyether polyols, stearic acid, lauric acid, isopropyl alcohol, benzene derivatives, butylated hydroxytoluene, triethanolamine, polyvinylidene fluoride, methyl ethyl ketone, dodecylbenzene, polyacrylamide, ethylhexyl stearate, glycerol esters, cetyl alcohol, decyl alcohol, dodecanol, propylene glycol, ethylene glycol, isopropanol, naphtha, diethylene glycol, butylene glycol, diethyl phthalate, phthalic acid, zinc stearate, calcium stearate, sodium bicarbonate, polyethylene oxide, ethylene oxide, fatty alcohol ethoxylates, magnesium silicate, polyvinyl pyrrolidone, polyisocyanate, acetic acid esters, ethyl acrylate, water-insoluble surfactants, a combination thereof, and the like. In a preferred embodiment, the defoamer is a DF-1 defoamer from TAQA.

The cementitious mixture includes a silica flour in an amount 10 to 20 wt. %, preferably 13 to 19 wt. %, more preferably 15 to 17 wt. %, and yet more preferably about 16.54 wt. % based on a total weight of the cementitious mixture. Silica flour is a fine powder made from crushed silica, typically derived from high-purity quartz. It is commonly used as a filler or additive in cement slurries, concrete, and other industrial applications to improve strength, durability, and chemical resistance. Examples of silica flour may include, but are not limited to, quartz flour, fumed silica, precipitated silica, microsilica, silica gel, amorphous silica, silica powder, silicon dioxide, silica sand, white silica, silica dust, silicate minerals, diatomaceous earth, microfine silica, silica nanopowder, hydrated silica, industrial grade silica, synthetic silica, silica ash, nano-silica, silica oxide, quartz powder, fine silica, silica-rich material, silica beads, silica flour powder, silicon oxide, fumed silica powder, silica sand powder, silica slurry, silica filler, silica gel beads, silica grains, silicate powder, high-purity quartz flour, silica microparticles, silica nanoparticles, colloidal silica, silica aggregates, silica clays, non-crystalline silica, synthetic fumed silica, precipitated silica gel, silica gel powder, non-hydrated silica, silica aggregates, silicate minerals powder, silica pigment, ultra-fine silica, nano-silica powder, precipitated silica gel, sodium silicate, high-grade silica flour, silica-rich quartz, amorphous silicon dioxide, hydrated silica powder, milled silica, ultrafine silica, hydrated quartz, silicate compounds, high-density silica, silica-rich fillers, crushed silica, fine quartz powder, silica fume, silica sand flour, silica oxide powder, silica particulate, micronized silica, non-porous silica, powdered silica gel, amorphous silicon powder, pure silica powder, fine-grain silica, crystalline-free silica, industrial silica flour, amorphous silica gel, a combination thereof, and the like. In a preferred embodiment, the silica flour is at least 99.9% pure SiO₂.

The cementitious mixture includes magnetite in an amount of 10 to 20 wt. %, preferably 11 to 18 wt. %, more preferably 12 to 13 wt. %, and yet more preferably about 12.68 wt. %, based on a total weight of the cementitious mixture. In other embodiments, the cementitious mixture includes magnetite in an amount of 5 to 40 wt. % based on a total weight of the cementitious mixture. In some embodiments, the magnetite includes at least 95 wt. % iron, preferably at least 96 wt. % iron, preferably at least 97 wt. % iron, more preferably at least 98 wt. % iron, and yet more preferably at least 98.5 wt. % iron based on the total weight of atoms other than oxygen in the magnetite. In some embodiments, the magnetite includes at least 99 wt. % iron based on the total weight of atoms other than oxygen in the magnetite. In some embodiments, the magnetite includes about 99.55 wt. % iron, about 0.17 wt. % titanium, about 0.12 wt. % silicon, about 0.05 wt. % chlorine, about 0.03 wt. % potassium, about 0.02 wt. % calcium, and other elements constituting about 0.06 wt. %. In some embodiments, the magnetite has a particle size of 15 to 20 um, preferably 16 to 19.5 μm, more preferably 18 to 19 μm, and yet more preferably about 18.84 um. In some embodiments, the magnetite has a specific gravity of 5 to 5.5, preferably 5.1 to 5.3, more preferably 5.15 to 5.2, and yet more preferably about 5.17.

In some embodiments, the incorporation of magnetite into a cementitious mixture results in a 10 to 30% increase, preferably a 12 to 28% increase, preferably a 15 to 25% increase, more preferably a 19 to 23% increase, and yet more preferably about a 21% increase in compressive strength compared to a cementitious mixture with the incorporation of hematite. In some embodiments, the cementitious mixture including magnetite demonstrates a low-density variation of 5 to 10%, preferably 6 to 9%, more preferably 7 to 8%, and more preferably about 7.3%. In some embodiments, the cementitious mixture including hematite exhibits a density variation of 6 to 12%, preferably 7 to 11%, more preferably 8 to 10%, and yet more preferably about 8.7%. In some embodiments, the cementitious mixture including magnetite reduces the porosity and permeability of cured cement samples compared to those prepared with hematite.

In some embodiments, the cementitious mixture further includes hematite in an amount of 10 to 20 wt. %, preferably 11 to 18 wt. %, more preferably 12 to 14 wt. %, and yet more preferably about 12.55 wt. % based on a total weight of the cementitious mixture. In some embodiments, the hematite includes at least 95 wt. % iron, preferably at least 96 wt. % iron, preferably at least 97 wt. % iron, and preferably at least 98 wt. % iron based on the total weight of atoms other than oxygen in the hematite. In some embodiments, the hematite includes about 95.84 wt. % iron, about 0.01 wt. % titanium, about 0.5 wt. % silicon, about 0.32 wt. % chlorine, about 0.21 wt. % potassium, about 0.03 wt. % calcium, and other elements constituting about 3.08 wt. %. In some embodiments, the hematite has a particle size of about 15 to 20 μm, preferably 16 to 19 μm, more preferably 16.5 to 18 um, and yet more preferably 16.86 μm. In some embodiments, the hematite has a specific gravity of 5 to 5.5, preferably 5.1 to 5.4, more preferably 5.2 to 5.3, and yet more preferably about 5.26.

In other embodiments, alternative options of magnetite and hematite in the cementitious mixture may include, but are not limited to, barite, barytes, iron oxide, calcium carbonate, zinc oxide, wollastonite, sand, silica flour, talc, fly ash, clay, bentonite, perlite, mica, glass beads, limestone, gypsum, diatomaceous earth, ceramics, alumina, feldspar, graphite, dolomite, barite powder, quartz, kaolin, silica gel, slate, dolomitic lime, calcium hydroxide, pyrite, vermiculite, sodium bentonite, calcium sulfate, phosphates, plaster of Paris, iron sulfate, aluminum sulfate, magnesium sulfate, chrome ore, fluorspar, cement kiln dust, silica sand, Portland cement, hydrated lime, sodium chloride, potassium chloride, polypropylene, polyethylene, styrene, methyl methacrylate, polyvinyl alcohol, epoxy resin, polyurethane, polycarbonate, phenolic resin, urethane, sodium acetate, polyethylene glycol, polystyrene, polysiloxane, calcium silicate, sodium metasilicate, magnesium silicate, bauxite, attapulgite, perlite powder, glass microspheres, resin beads, sodium carbonate, sodium bicarbonate, iron chloride, copper slag, steel slag, lead oxide, silicon carbide, titanium dioxide, aluminum oxide, cobalt, nickel oxide, ferric oxide, lithium carbonate, strontium carbonate, potassium carbonate, manganese dioxide, copper oxide, chromium oxide, lead sulfate, calcium aluminate, barium sulfate, magnesium carbonate, sodium sulfate, ammonium nitrate, sodium hydroxide, phosphoric acid, silica gel, zinc sulfate, calcium nitrate, hydrogen peroxide, sodium silicate, iron carbonate, fluorosilicic acid, tetraethyl orthosilicate, ferrous sulfate, borax, calcium formate, sodium formate, a combination thereof, and the like.

The cementitious mixture is injected into an annulus between a casing and a wellbore wall. In some embodiments, the cementitious mixture can by injected into a cased wellbore via cementing techniques, such as primary cementing, squeeze cementing, plug cementing, tagging cement, cementing with coiled tubing, inert gas-enhanced cementing, batching cement into the wellbore (batching method), dual pipe or dual string cementing, cementing via a jetting tool, cementing with multistage tools (ball drop or sleeve systems), a combination thereof, and the like.

In some embodiments, materials such as steel, stainless steel, carbon steel, alloy steel, titanium, fiberglass, composite materials, aluminum, polyvinyl chloride, high-density polyethylene, a combination thereof, and the like may be used to make the casing.

In one or more embodiments, the wellbore may be present in an oil well, a gas well, a production well, an injection well, a naturally flowing well, an artificially lifted well, a high-temperature well, a steam-assisted gravity drainage well, a steam injector well, a geothermal well, a combination thereof, and the like. The wellbore may be formed by known techniques. In some embodiments, the well may be a horizontal well, a vertical well, a multilateral well, a combination thereof, and the like.

At step 54, the method 50 includes curing the cementitious mixture to form a cured cement connecting the casing to the wellbore wall. In some embodiments, the cementitious mixture is cured in the well at a pressure of 2500 to 3500 psi, preferably 2600 to 3400 psi, preferably 2700to 3300 psi, preferably 2800 to 3200 psi, preferably 2900 to 3100, and preferably about 3000 psi, and a temperature of 270 to 320° F., preferably 280 to 310° F., preferably 290 to 300° F., for 20 to 24 hours, preferably 21 to 23 hours, and preferably about 22 hours.

In some embodiments, the cured cement containing magnetite has a compressive strength of 60 to 70 MPa, preferably 62 to 68 MPa, more preferably 64 to 66 MPa, and yet more preferably about 65.1 MPa. In some embodiments, the cured cement containing hematite has a compressive strength of 45 to 55 MPa, preferably 47 to 53 MPa, more preferably 49 to 51 MPa, and yet more preferably about 50.8 MPa.

In some embodiments, the cured cement containing magnetite has a permeability of 0.0025 to 0.0035 mD, preferably 0.0026 to 0.0034 mD, more preferably 0.0028 to 0.0032 mD, and yet more preferably about 0.003 mD.

In some embodiments, the cured cement containing magnetite has a density dissimilarity of 5 to 8%, preferably 6 to 7.8%, more preferably 6.5 to 7.5%, and yet more preferably about 7.3%. In some embodiments, the cured cement containing hematite has a density dissimilarity of 8 to 10%, preferably 8.2 to 9.5%, more preferably 8.5 to 9%, and yet more preferably about 8.7%.

In some embodiments, the cured cement containing magnetite has a tensile strength of 6 to 10 MPa, preferably 7 to 9 MPa more preferably 7.5 to 8.5 MPa, and yet more preferably about 8.1 MPa.

In some embodiments, the cured cement containing magnetite has a porosity of 21 to 25%, preferably 21.3 to 24%, more preferably 21.8 to 23%, and yet more preferably about 22%. In some embodiments, the cured cement containing hematite has a porosity of 20 to 24%, preferably 21 to 23.7%, more preferably 22 to 23.2%, and yet more preferably about 23%.

In some embodiments, the cured cement containing hematite has a permeability of 0.003to 0.004 mD, preferably 0.0032 to 0.0038 mD, more preferably 0.0034 to 0.0036 mD, and yet more preferably about 0.0035 mD.

The cementitious mixture including magnetite may be applicable for both onshore and offshore fields. In onshore fields, the cementitious mixture and cured cement promotes wellbore integrity, zonal isolation, and fluid control, with its high-density properties to manage high-pressure formations and prevent fluid migration. In offshore fields, the cementitious mixture including magnetite provides enhanced strength, density, and durability, addressing challenge of deep-water drilling and subsea operations, such as resistance to washouts and improved bonding in extreme conditions. The cementitious mixture including magnetite may be effective for cementing deep and ultra-deep wells, where temperatures range from 50° C. to 300° C.

### EXAMPLES

The following examples describe and demonstrate a method for cementing a well and a cementitious mixture. The examples are provided solely for illustration and are not to be construed as limitations of the present disclosure, as many variations thereof are possible without departing from the spirit and scope of the present disclosure.

### Example 1: Materials (Cement Slurries)

All cement slurries were prepared with the compositions listed in Table 1. Except for the weighting material, all cement slurries have the same composition. The two cement formulations are made consistently for the composition to fulfill the targeted density of 18 pounds mass per gallon (lbm/gal) and have different weighting materials, such as hematite and magnetite, to attain that density.

TABLE 1
The additives in the cement samples

| Component | Hematite-based (g) | Magnetite-based (g) |
|---|---|---|
| Class G cement | 600 | 600 |
| Water | 264 | 264 |
| Retarder | 9 | 9 |
| Dispersant | 1.5 | 1.5 |
| Fluid loss additive | 3 | 3 |
| Defoamer | 3 drops | 3 drops |
| Silica flour | 210 | 210 |
| Hematite | 182.3 | 0 |
| Magnetite | 0 | 184.4 |

The elemental composition of weighting agents was determined using X-ray fluorescence (XRF) spectroscopy. A service provider supplied hematite and magnetite cement with the compositions listed in Table 2, as determined by XRF. The purity of hematite and magnetite particles is detected with the iron levels around 96 wt. % and 99.6 wt. %, respectively. The values of the specific gravity of Class G cement and the weighted agents are listed in Table 3.

TABLE 2
Hematite and magnetite chemical
composition as determined by XRF

| Component | Hematite (wt. %) | Magnetite (wt. %) |
|---|---|---|
| Fe | 95.84 | 99.55 |
| Ti | 0.01 | 0.17 |
| Si | 0.5 | 0.12 |
| Cl | 0.32 | 0.05 |
| K | 0.21 | 0.03 |
| Ca | 0.03 | 0.02 |
| Others | 3.08 | 0.06 |

TABLE 3
The specific gravity of class G slurry and weighted agents

| Material | Specific gravity |
|---|---|
| Class G cement | 3.15 |
| Hematite | 5.26 |
| Magnetite | 5.17 |

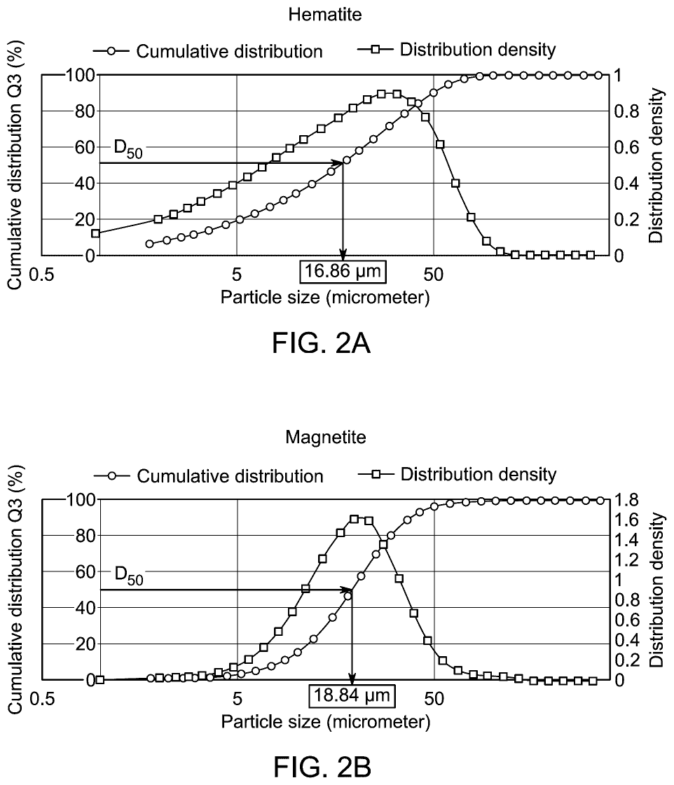

Particle size and particle size distribution (PSD) were examined using an ANALYSETTE 22 device by Fritsch company as it was employed to analyze properties of the weighting agents. FIGS. 2A-2B depict the PSD of the weighted materials. The figures represent the D₁₀and D₉₀ particle sizes of small and large particles and the intermediate particle size of the employed weighting materials (D₅₀). The magnetite particles (D₅₀) were slightly larger than hematite materials, 18.84 microns and 16.86 microns, respectively.

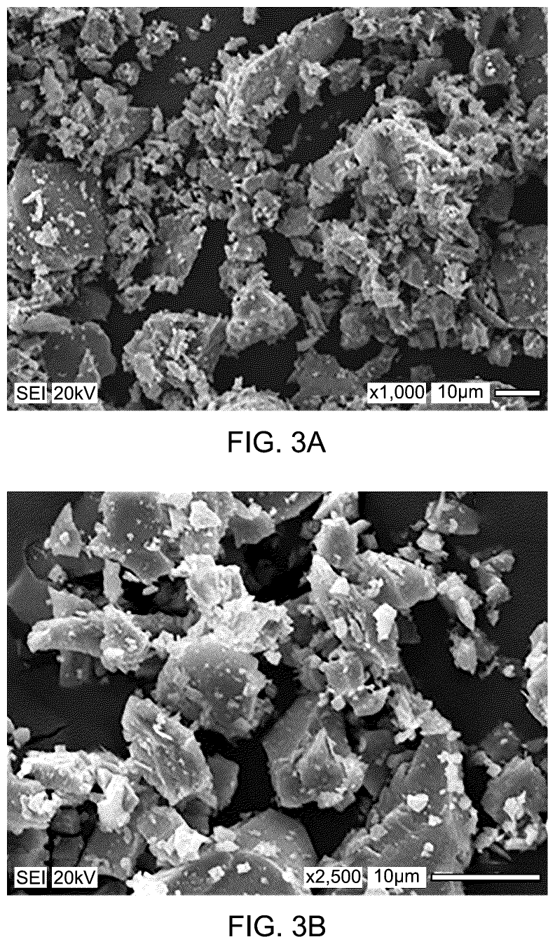

Microscopic images of the weighting agents were captured using scanning electron microscopy (SEM) and are shown in FIGS. 3A-3B. Both elements of weighting materials show an irregular shape. Hematite and magnetite have heterogeneous particles with distinctive forms and sharp edges, indicating that both additives are abrasive, as shown in FIGS. 3A-3B. The hematite and magnetite samples have particles equipped with an average particle size of 16.86 microns and 18.84 microns, respectively, as seen in FIGS. 2A-2B.

### Example 2: Sample Preparations

Slurries of the two samples were mixed based on American petroleum institute (API) standards and transferred into metallic cubic and cylindrical molds [API Specification 10A, 2010;and Recommended Practice 10B-2, 2013, which are incorporated herein by reference in their entireties]. The molds have cylindrical boundaries with dimensions of 1.5 inches in diameter and 4 inches in length. The slurries were cured in a high pressure and high temperature (HPHT) curing chamber at 294 (degrees Fahrenheit)° F. and 3000 psi after 24 hours of curing. The cement samples were collected from a curing machine after 24 hours and stored using metallic molds to assess the changes in various qualities.

### Example 3: Density Variation

Two cylindrical samples, each having a diameter of about 1.5 inches and a length of 4 inches, were used to investigate density dissimilarity. Density measurements of the top and bottom sections were used to determine the homogeneity of the samples. Further, the two cement samples with the same diameter, having a 0.5-inch difference in length, were divided into small pieces at the top, center, and bottom to equally see the density dissimilarity in those locations according to the larger sample comparison. The density of the miniature cement cylinders was calculated with respect to the volume and weight of the miniature cement cylinders.

### Example 4: Compressive Strength Measurement

The cubical samples were evaluated for compressive strength according to API and American Society for Testing and Materials (ASTM) standards [ASTM C109, 2020; and Recommended Practice 10B-2, 2013, which are incorporated herein by references in their entireties]. To determine compressive strength, the cement blocks were continuously exposed to compression stress at a rate of 1.5 kilonewtons per second (KN/s) up until the cement blocks broke down. The highest compression load determined the compressive strength of the sample and that the sample may withstand. To compute the compressive strength of each specimen, the average compressive strength of two blocks of cement was used.

### Example 5: Tensile Strength Measurement

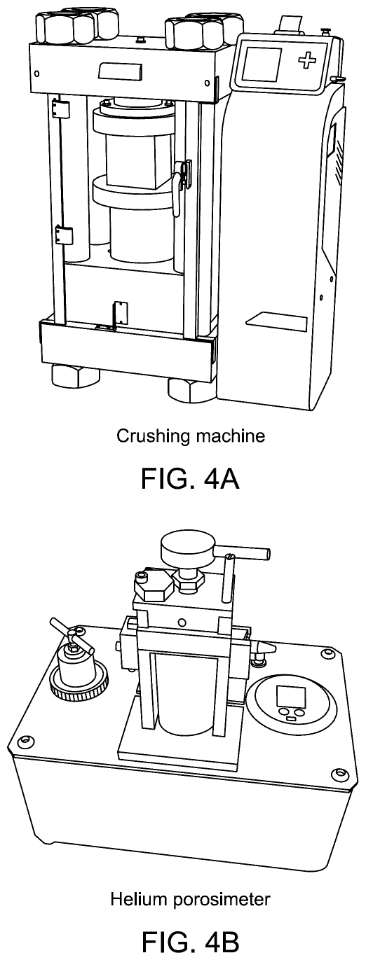

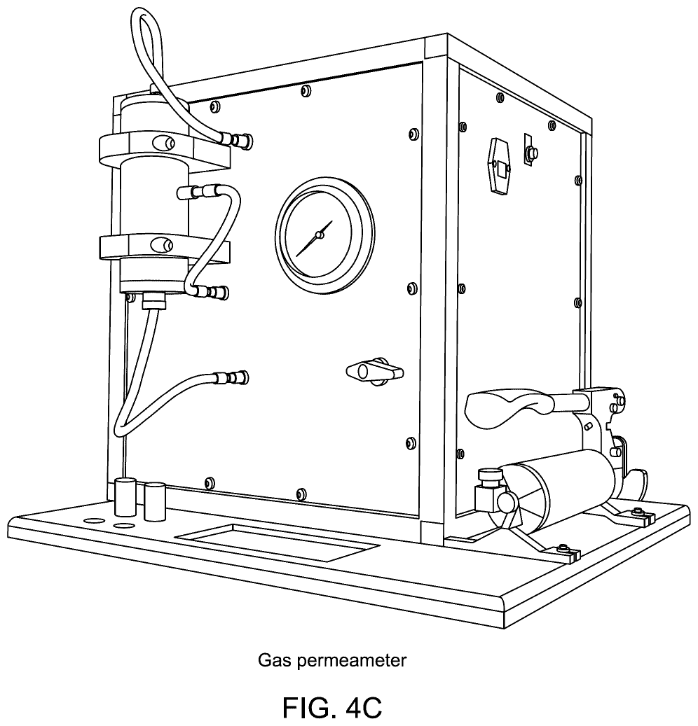

The tensile strength testing machine is represented in FIG. 4A. Using indirect measurement, Brazilian tensile strength of two slurries were utilized to assess the cement tensile strength by taking an average value from two cylindrical samples. Two samples, each having a diameter of 1.5 inches and a length of 0.9 inches, were placed horizontally as the cement blocks were characterized by frequent compression stress at a 1.5 KN/s rate. Using equation 1, the tensile strength of the two cylindrical samples was calculated indirectly concerning the highest load it may bear before breaking.

$$σ t = \frac{2 P}{π dl} \qquad ( 1 )$$

“σt” denotes the Brazilian tensile strength in megapascal (MPa), the greatest load the slurry may bear before crashing in is denoted by “P,” “d” represents the diameter in millimeters, and “1” is the length in millimeters of the two cylindrical slurries.

### Example 6: Porosity and Permeability Measurement

The porosity was measured using a helium porosimeter and application of Boyle's law, equation 2, [Peters, E. J., Advanced Petrophysics, 2012, Vol. 1, pg. 2-7, which is incorporated herein by reference in its entirety]. Permeability was determined using the same method described by the Hagen-Poiseuille law, equation 3, [Sanjuán, M. A. and Muñoz-Martialay, R., Influence of the age on air permeability of cement sheath concrete, Journal of Materials Science, 1995, 30, 22, which is incorporated herein by reference in its entirety]. FIG. 4B and FIG. 4C show the helium porosimeter and gas permeameter, respectively.

$$V = \frac{1 - 2 {( \frac{Vt}{Vl} )}^{2}}{2 - 2 {( \frac{Vt}{Vl} )}^{2}} \qquad ( 2 )$$

$$E = \frac{{Vl}^{2} ρ ( 1 + v ) ( 1 + 2 v )}{1 - v} \qquad ( 3 )$$

“Vt” is longitudinal velocity longitudinal velocity in feet per second (ft/sec), “Vl” is the shear velocity in ft/sec, and “ρ” is the density in lbm/gal.

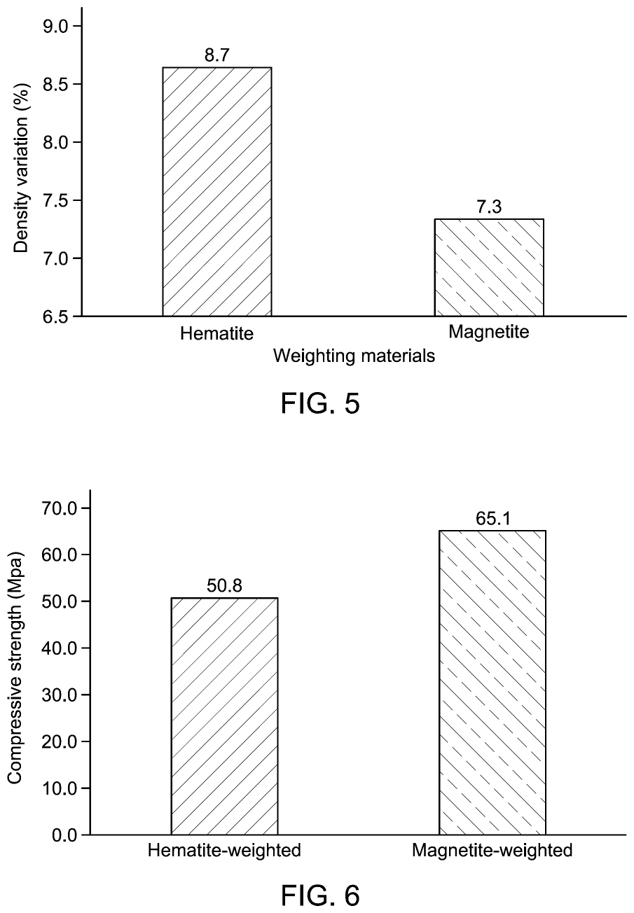

Density fluctuation of the samples from top to bottom was investigated. The percentage density fluctuation along the sample is shown in FIG. 5. With an 8.7% density difference from top to bottom, the density variance within the hematite slurry is highest. A 7.3% density difference along the magnetite cement sample is observed. The observation may be linked to the particle size distribution, as seen in FIGS. 2A-2B, implying that using large particle weighting materials may cause vertical heterogeneity along the sample.

FIG. 6 depicts a comparison of the compressive strength of cement samples made with hematite and magnetite. The magnetite sample exhibits the highest compressive strength of 65.1 MPa, which is about 21% higher than the hematite sample, according to compression strength testing, as shown in FIG. 6. The compressive strength of the magnetite-weighted cured cement was noted to be more than 7000 KPa or 1000 psi after 24 hours of curing, indicating the smallest permissible compressive strength of a slurry under seven days of testing [Eilers, L. H. and Nelson, E. B. (1979). Effect of silica particle size on degradation of silica stabilized Portland cement, Society of Petroleum Engineers—SPE Oilfield and Geothermal Chemistry Symposium, 1979, which is incorporated herein by reference in its entirety].

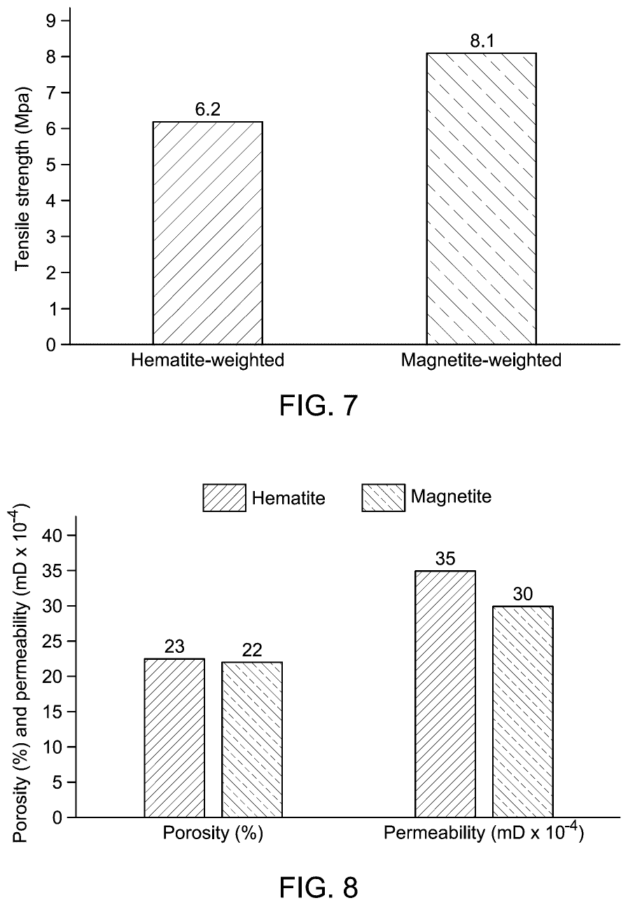

FIG. 7 depicts a comparison of the tensile strength of cement samples made using hematite and magnetite. The magnetite sample has a maximum tensile strength of 8.1 MPa, which is about 23% higher than the hematite sample. The tensile strength of the magnetite sample is around 15% of the compressive strength. A higher tensile strength may be favored since it shows that the cement may hold up under tension.

FIG. 8 shows a comparison of the porosity and permeability of hematite-based and magnetite-based samples. The porosity and permeability of the magnetite sample were 1.8% and 16.7%, respectively, which is lower than the porosity and permeability of the hematite sample.

The porosity and permeability of the hematite sample were 23% and 35×10−4 mD, respectively. Although the particle size of magnetite is larger than that of hematite, as shown in FIGS. 2A-2B, the concentration of magnetite is higher than hematite, as shown in Table 1, which may explain the low porosity and permeability of magnetite-weighted cement.

Aspects of the present disclosure provide a method of cementing a well. Parameters like density dissimilarity, compressive strength, porosity, and permeability were evaluated for hematite and magnetite weighting materials to determine their effect on the qualities of class G cement, which may be used for cementing oil wells. Further, the present disclosure examined the effectiveness of using magnetite as a weighting component when cementing a deep well at a depth of about 15,000 feet. The density variance within the hematite slurry was the highest at about 8.7%, followed by a 7.3% density difference for the magnetite cement sample. The magnetite sample exhibited the highest compressive strength of 65.1 MPa, which was about 21% higher than the hematite sample. The magnetite sample exhibited a 23% higher tensile strength than the hematite sample, which is desirable as higher tensile strength shows that the cement may hold up under tension. The porosity and permeability of the magnetite sample were 1.8% and 16.7%, respectively, which was lower than the porosity and permeability of the hematite sample. The magnetite-based cement exhibited a low Young's modulus at about 21 gigapascals (GPa), indicating that magnetite provided elasticity and has stability under shear stresses while maintaining low lateral expandability with a 0.23 Poisson's ratio. The capacity of the magnetite-based cement to lower the Poisson's ratio and boost cement elasticity is favorable for cementing deep wells.

Numerous modifications and variations of the present disclosure are possible in light of the above teachings. It is therefore to be understood that within the scope of the appended claims, the disclosure may be practiced otherwise than as specifically described herein.

1. A method of cementing a well, comprising:
injecting a cementitious mixture into a cased wellbore at a depth of at least 10,000 feet, wherein the cementitious mixture is injected into an annulus between a casing and a wellbore wall, and
curing the cementitious mixture to form a cured cement connecting the casing to the wellbore wall,
wherein the cementitious mixture comprises:
a class G cement in an amount of 40 to 50 percent by weight (wt. %);
water in an amount of 15 to 25 wt. %;
a retarder in an amount of 0.5 to 1 wt. %;
a dispersant in an amount of 0.05 to 0.2 wt. %;
a fluid loss additive in an amount of 0.1 to 0.3 wt. %;
a defoamer in an amount of 0.001 to 0.05 wt. %;
a silica flour in an amount 10 to 20 wt. %; and
magnetite in an amount of 10 to 20 wt. %,
wherein the wt. % is based on a total weight of the cementitious mixture.

2. The method of claim 1, wherein the magnetite comprises at least 95 wt. % iron based on the total weight of atoms other than oxygen in the magnetite.

3. The method of claim 1, wherein the magnetite comprises at least 99 wt. % iron based on the total weight of atoms other than oxygen in the magnetite.

4. The method of claim 1, wherein the magnetite has a particle size of 15 to 20 μm.

5. The method of claim 1, wherein the magnetite has a specific gravity of 5 to 5.5.

6. The method of claim 1, wherein the cementitious mixture is cured in the well at a pressure of 2500 to 3500 psi and a temperature of 270 to 320° F. for 20 to 24 hours.

7. The method of claim 6, wherein the cured cement has a compressive strength of 60 to 70 MPa.

8. The method of claim 6, wherein the cured cement has a permeability of 0.0025 to 0.0035 mD.

9. The method of claim 6, wherein the cured cement has a density dissimilarity of 5 to 8%.

10. The method of claim 6, wherein the cured cement has a tensile strength of 6 to 10 MPa.

11. The method of claim 6, wherein the cured cement has a porosity of 20 to 24%.

12. The method of claim 1, wherein the cementitious mixture further comprises hematite.

13. The method of claim 12, wherein the hematite comprises at least 95 wt. % iron based on the total weight of atoms other than oxygen in the hematite.

14. The method of claim 12, wherein the hematite has a particle size of 15 to 20 μm.

15. The method of claim 12, wherein the cementitious mixture is cured in the well at a pressure of 2500 to 3500 psi and a temperature of 270 to 320° F. for 20 to 24 hours.

16. The method of claim 15, wherein the cured cement has a compressive strength of 45 to 55 MPa.

17. The method of claim 15, wherein the cured cement has a permeability of 0.003 to 0.004 mD.

18. The method of claim 15, wherein the cured cement has a density dissimilarity of 8 to 10%.

19. The method of claim 15, wherein the cured cement has a tensile strength of 4 to 8 MPa.

20. The method of claim 15, wherein the cured cement has a porosity of 21 to 25%.
